(19) United States
(12) Patent Application Publication
(10) Pub. No.: US 2025/0245506 A1
(43) Pub. Date: Jul. 31, 2025

(54) METHOD AND APPARATUS FOR GENERATING PERSONA-BASED MULTIMODAL BACK-CHANNEL SIGNAL

(71) Applicant: ELECTRONICS AND TELECOMMUNICATIONS RESEARCH INSTITUTE, Daejeon (KR)

(72) Inventors: Seung YUN, Daejeon (KR); Seung-Hi KIM, Daejeon (KR); Jeong-Uk BANG, Daejeon (KR)

(21) Appl. No.: 18/931,770

(22) Filed: Oct. 30, 2024

(30) Foreign Application Priority Data
Jan. 26, 2024 (KR) 10-2024-0012210

(51) Int. Cl. G06N 3/084; G10L 15/16

(52) U.S. Cl. CPC G06N 3/084; G10L 15/16

(57) ABSTRACT

Disclosed herein are a method and apparatus for generating a persona-based multimodal back-channel signal. The method may include training an artificial intelligence model that generates back-channel signal information using a multimodal database (DB) with channel signal information labels applied thereto, performing fine-tuning on the artificial intelligence model using a preset speaker database, and generating back-channel signal information for input video or audio based on the artificial intelligence model.

### CROSS REFERENCE TO RELATED APPLICATION

This application claims the benefit of Korean Patent Application No. 10-2024-0012210, filed Jan. 26, 2024, which is hereby incorporated by reference in its entirety into this application.

### BACKGROUND OF THE INVENTION

### 1. Technical Field

The present disclosure relates generally to persona-based multimodal interactive back-channel signal generation technology.

### 2. Description of Related Art

A back-channel signal refers to short vocalizations, facial expressions, eye movements, head gestures, or a combination thereof, used by a listener to indicate that the listener is paying attention to the speaker or to request the speaker to continue talking. In conversations between people, back-channel signals are typically conveyed to the speaker periodically depending on the style of the listener.

Recently, with the development of artificial intelligence technology, technology related to conversation systems, such as such as digital humans, intelligent robots, and voice avatar chatbots, is widespread.

However, digital humans, intelligent robots, and voice avatar chatbots that are currently utilized are capable of making simple conversations with humans but are not yet able to convey interaction through back-channel signal information. When the back-channel signal information is not conveyed, those conventional systems fail to properly fulfill the role of a listener, thus significantly reducing the naturalness of interaction and making it difficult to immerse in conversation.

In particular, it is even more difficult for the conventional systems to generate and output simple back-channel signals based on a specific persona desired to represent as a listener beyond simple back-channel signal generation.

### PRIOR ART DOCUMENTS

### Patent Documents

(Patent Document 1) Korean Patent Application Publication No. 2021-0146089 (Title of the invention: Device and Method for Generating Conversational Model Using Knowledge and Persona)

### SUMMARY OF THE INVENTION

Accordingly, the present disclosure has been made keeping in mind the above problems occurring in the prior art, and an object of the present disclosure is to output customized multimodal interactive back-channel signal information corresponding to a persona.

Another object of the present disclosure is to provide an interactive conversation service using back-channel signal information.

In accordance with an aspect of the present disclosure to accomplish the above objects, there is provided a method for generating a persona-based multimodal back-channel signal, including training an artificial intelligence model that generates back-channel signal information using a multimodal database (DB) with channel signal information labels applied thereto; performing fine-tuning on the artificial intelligence model using a preset speaker database; and generating back-channel signal information for input video or audio based on the artificial intelligence model.

The multimodal database may include data composed of video, audio and text information.

The back-channel signal information label may include video and audio labels of a listener and a speaker; and a back-channel information label of the listener.

The video label may include eye movement, lip shape, gesture, and head movement information, and the audio label may include accent and audio duration information.

The speaker database may be set based on a generation frequency of a back-channel signal of the listener.

Training the artificial intelligence model may include determining a length of a multimodal signal that is input to the artificial intelligence model; performing preprocessing on the multimodal signal; and outputting the back-channel signal information based on information in which individual preprocessed signals are concatenated with each other.

Generating the back-channel signal information based on the input video or audio may include inputting the input video or audio based on the determined length of the multimodal signal and a preset hop length.

The method may further include outputting video or audio based on the back-channel signal information.

The back-channel signal information may be video or audio information used by the listener to pay attention to the speaker or to request the speaker to continue talking.

In accordance with another aspect of the present disclosure to accomplish the above objects, there is provided an apparatus for generating a persona-based multimodal back-channel signal, including memory configured to store at least one program; and a processor configured to execute the program, wherein the program may include instructions for performing training an artificial intelligence model that generates back-channel signal information using a multimodal database (DB) with channel signal information labels applied thereto; performing fine-tuning on the artificial intelligence model using a preset speaker database; and generating back-channel signal information for input video or audio based on the artificial intelligence model.

The multimodal database may include data composed of video, audio and text information.

The back-channel signal information label may include video and audio labels of a listener and a speaker; and a back-channel information label of the listener.

The video label may include eye movement, lip shape, gesture, and head movement information, and the audio label may include accent and audio duration information.

The speaker database may be set based on a generation frequency of a back-channel signal of the listener.

Training the artificial intelligence model may include determining a length of a multimodal signal that is input to the artificial intelligence model; performing preprocessing on the multimodal signal; and outputting the back-channel signal information based on information in which individual preprocessed signals are concatenated with each other.

Generating the back-channel signal information based on the input video or audio may include inputting the input video or audio based on the determined length of the multimodal signal and a preset hop length.

The program may further include an instruction for performing outputting video or audio based on the back-channel signal information.

The back-channel signal information may be video or audio information used by the listener to pay attention to the speaker or to request the speaker to continue talking.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart illustrating a method for generating a persona-based multimodal back-channel signal according to an embodiment of the present disclosure;

FIG. 2 is a configuration diagram of a trainer for a persona-based multimodal interactive back-channel signal information output model according to an embodiment of the present disclosure;

FIG. 3 is a configuration diagram of a multimodal interactive back-channel signal information output model;

FIG. 4 is a configuration diagram of a persona-based back-channel signal information output device;

FIG. 5 is a configuration diagram of a video/audio (text) signal generator based on persona-based back-channel signal information; and

FIG. 6 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Hereinafter, embodiments of the present disclosure will be described in detail with reference to the accompanying drawings. In the following description of the present disclosure, the same reference numerals are used to designate the same or similar elements throughout the drawings and repeated descriptions of the same components will be omitted.

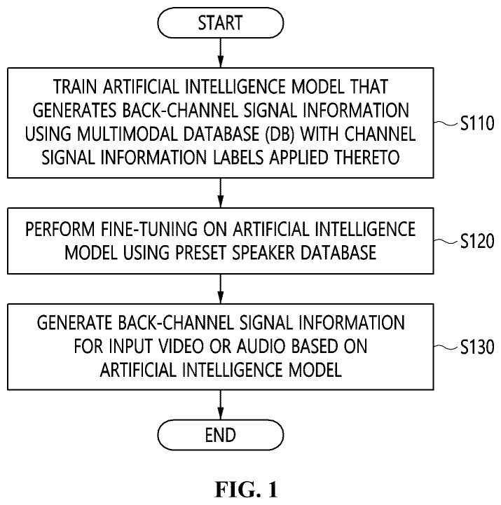

FIG. 1 is a flowchart illustrating a method for generating a persona-based multimodal back-channel signal according to an embodiment of the present disclosure.

The method for generating a persona-based multimodal back-channel signal according to an embodiment of the present disclosure may be performed by an apparatus for generating a persona-based multimodal back-channel signal, such as a computing device, a server, or the like.

Referring to FIG. 1, the method for generating a persona-based multimodal back-channel signal according to the embodiment of the present disclosure may include step S110 of training an Artificial Intelligence (AI) model which generates back-channel signal information using a multimodal database (DB) with back-channel signal information labels (i.e., back-channel signal information) applied thereto, step S120 of performing fine-tuning on the artificial intelligence model using a preset speaker database (DB), and step S130 of generating back-channel signal information depending on input video (image) or audio (voice or speech) based on the artificial intelligence model.

Here, the multimodal database may include data composed of video, audio, and text information.

Here, the back-channel signal information labels may include video and audio labels of a listener and a speaker and the back-channel information label of the listener.

Here, the video labels may include information about eye movements, lip shapes, gestures, and head movements, and the audio labels may include information about accent, speech duration, etc.

Here, the speaker database may be set based on the generation frequency of the back-channel signal of the listener.

Here, step S110 of training the artificial intelligence model may include the step of determining the length of a multimodal signal input to the artificial intelligence model, the step of performing preprocessing on the multimodal signal, and the step of outputting back-channel signal information based on information in which individual preprocessed signals are concatenated with each other.

Here, step S130 of generating the back-channel signal information based on the input video or audio may include the step of inputting the input video or audio based on the determined length of the multimodal signal and a preset hop length.

Further, the method may further include the step of outputting video or audio based on the back-channel signal information.

Here, the back-channel signal information may correspond to video or audio information used by the listener in order for the listener to pay attention to the speaker or request the speaker to continue talking.

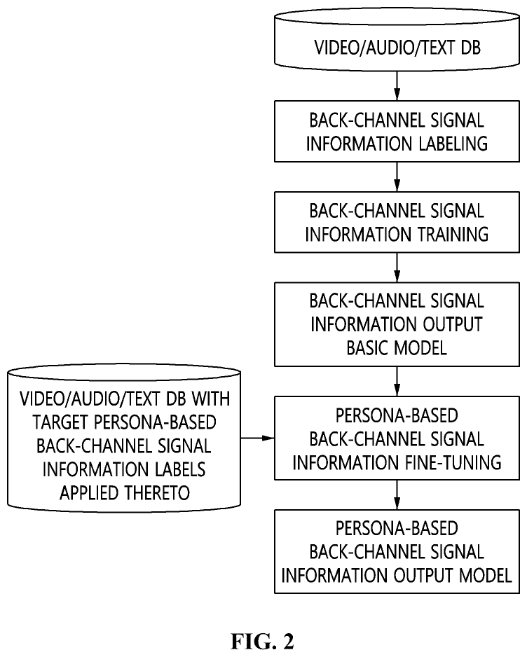

Hereinafter, embodiments of the present disclosure will be described in detail with reference to FIGS. 2 to 5.

FIG. 2 is a configuration diagram of a trainer for a persona-based multimodal interactive back-channel signal information output model according to an embodiment of the present disclosure.

Referring to FIG. 2, a multimodal database (DB) composed of video, audio, and text corresponding to the situation of a conversion between two or more persons is constructed. Thereafter, back-channel signal information labels are applied to the database. Targets to be applied may correspond to video/audio labels related to video/audio of all conversation participants, and back-channel information labels at time points at which back-channel signals occur from the standpoint of the listener.

For the video, labels in examples such as ‘nodding (e.g., up and down, left and right (including angles), etc.)’, ‘eye movements (e.g., widening eyes in surprise, closing eyes, etc., excluding physiological blinking)’, ‘lip shapes (e.g., smiling and the degree of smiling (e.g., levels indicating whether it is a slight smile or a broad grin, etc.))’, ‘gestures (e.g., raising both arms (angle of raising, elbow angle, speed, etc.), raising one arm (whether the arm is a left arm or right arm, angle of raising, elbow angle, speed, etc.))’, ‘mouth opening (surprise)’, and ‘pouting (sadness)’ may be applied.

Further, for the audio, pieces of information such as ‘falling intonation’, ‘rising intonation’, ‘flat intonation’, and ‘duration’ may be labeled. For the text, the actual spoken text may be described.

For the types of back-channels produced by the listener, labels may be applied as examples, such as ‘neutral-continuing (e.g., in the case of audio, ‘Mm’, ‘Yes’, ‘Uh-huh’, ‘Yeah’, etc. and in the case of video, a brief nod), ‘neutral-understanding (e.g., in the case of audio, ‘Yes’ (prolonged), ‘Oh’ (prolonged), ‘Mm-hmm’ (prolonged), etc., and in the case of video, a big nod), ‘emotional-astonishment (e.g., in the case of audio, ‘Oh,’ ‘Oh dear,’ ‘Oh my’, ‘Wow’, and ‘Goodness’ in the case of video, ‘wide eyes’, ‘mouth open’, etc.)’, ‘emotional-positive surprise (related to something good, and in the case of video, ‘mouth open’)’, ‘emotional-negative surprise (related to something bad, and in the case of video, ‘mouth open’ or ‘pouting’)’, ‘emotional-confirmation (‘Really,’ ‘Indeed,’ ‘Right’—not actually prompting an answer)’, and ‘emotional-empathy (e.g., in the case of audio, ‘Right,’ ‘Yeah’, or ‘Exactly’, and in the case of video, big nod)’.

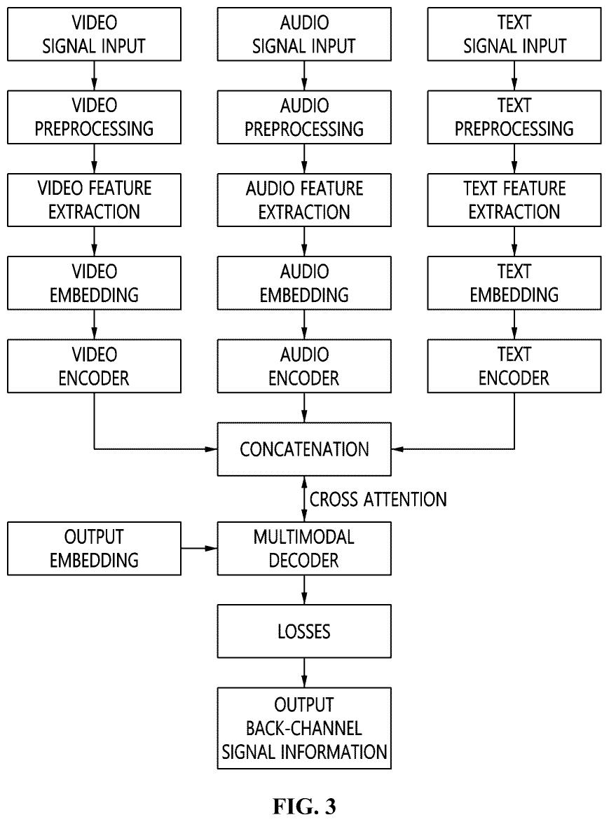

Thereafter, training is performed depending on the model structure of FIG. 3 so that the multimodal signal of the speaker is received and back-channel signal information (e.g., video/audio (text) labels and back-channel signal type labels) from the standpoint of the listener is output. It may be better to perform training for all of video/audio/text, but, when video signals are not present, training may be performed only for audio/text.

Here, when only audio/text signals are trained, the output labels may be output only for audio/text signals and back-channel signal type labels based on the audio/text signals. After training is terminated, a back-channel signal information output basic model is generated.

Next, a video/audio/text conversation database (DB) based on a targeted persona is prepared. The corresponding DB also needs to be labeled in the same form as the basic model. Here, the persona may be based on the conversation of a specific real person, or may be set to a speaker who outputs a lot of ‘emotional-empathy’ types of back-channels, a ‘speaker who frequently outputs back-channel signals themselves’, or a ‘speaker who intermittently outputs back-channel signals’ in an existing database constructed to train the base model. Further, it is possible to set the persona as a 20s female, 30s male, etc. As long as it is a persona that can be constructed into a database and can be trained, any type of persona may be set.

After the database is prepared, a persona-based back-channel signal information output model may be generated by performing fine-tuning with data of the target persona on the back-channel signal information output basic model.

FIG. 3 is a configuration diagram of a multimodal interactive back-channel signal information output model based on video/audio/text.

Referring to FIG. 3, the length of a multimodal signal to be used for training is determined. Simply, a time point corresponding to N seconds before the back-channel signal of a listener occurs (e.g., 2 seconds before, 2.5 seconds before, or 3 seconds before the occurrence of the back-channel signal) may be set to the time point at which a back-channel signal occurs. Alternatively, the time from the beginning of the utterance or from the previous silent segment may be set to the time point when the back-channel signal occurs. After training is performed in various manners, an optimal unit is set through the determination of training results, and the length of the corresponding signal is used for signal preprocessing for final modeling. However, in the case of text, even if the position, corresponding to N seconds before occurrence of a back-channel signal, appears in the middle of a token, the entirety of the correspond token is included in the unit so as to prevent the corresponding token from being disconnected at the middle position thereof.

First, video signals undergo preprocessing for deep learning (e.g., preprocessing such as splitting, magnification/reduction, rotation/transform, and gray scaling) to extract features (e.g., Hough transform, corner detection, etc.), after which embeddings for position encoding are extracted and are input to a video encoder. Here, the video encoder may be a transformer, a conformer, etc., but the scope of the present disclosure is not limited thereto.

Next, audio signals undergo preprocessing (e.g., splitting, sample frequency conversion, etc.) to perform a feature extraction process, after which embeddings for position encoding are extracted and are input to an audio encoder.

Here, the feature extraction process may correspond to Short-time Fourier Transform (STFT), extraction of a log-mel spectrogram through a Mel-filter bank, or extraction from a raw signal, but the scope of the present disclosure is not limited thereto.

Here, the audio encoder may be a transformer, a conformer, etc., but the scope of the present disclosure is not limited thereto.

Further, text undergoes preprocessing (e.g., text normalization, tokenization, etc.) to extract features (e.g., word order, context information, etc.), after which embeddings are extracted through text embedding (e.g., token embedding, segment embedding, position embedding, etc.) and are input to a text encoder.

Here, the text encoder may be a transformer, a conformer, or the like, but the scope of the present disclosure is not limited thereto.

At the next step, the results of the video encoder, the audio encoder, and the text encoder are concatenated to have cross attention with a multimodal decoder, the output embeddings are input to the multimodal decoder, and losses are calculated through a loss function (e.g., Softmax function) from the output of the multimodal decoder, after which back-channel signal information having the highest probability is output. The output may be video, audio and text labels, and back-channel signal type label information.

Here, the multimodal decoder may correspond to a transformer, but the scope of the present disclosure is not limited thereto.

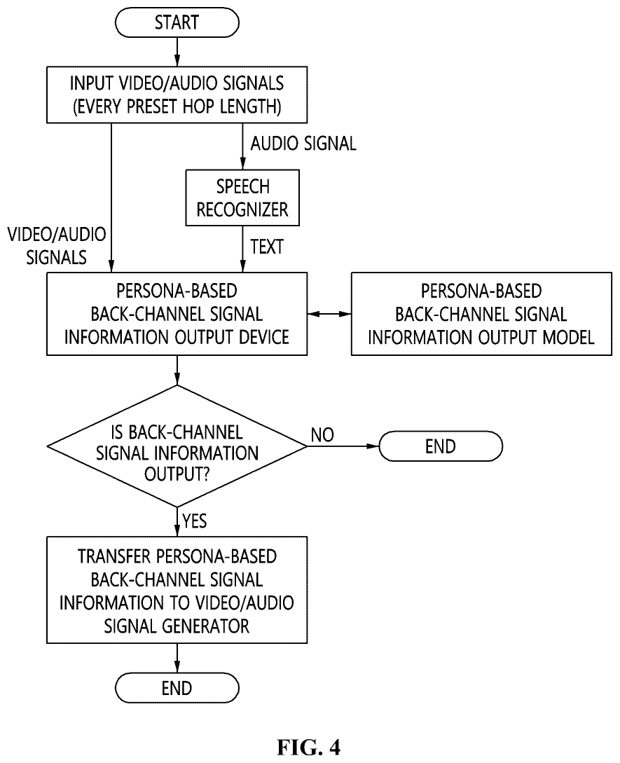

FIG. 4 is a configuration diagram of a persona-based back-channel signal information output device.

Referring to FIG. 4, the output device receives video/audio signal information, and outputs persona-based back-channel signal information. First, the input length (N seconds) of the input video/audio is determined. When an optimal training length determined in a training process is 2 seconds, the video/audio signals corresponding to a length of 2 seconds may be input and also be processed in real time by computer hardware at an output step. Within a range in which the video/audio signals are naturally felt when being output, a hop length may be set, and the video/audio signals are continuously input by hopping (e.g., every 0.5 seconds).

When the hop length is set to 0.5 seconds, the video/audio signals having a length of 2 seconds are input every 0.5 seconds, and thus results are repeatedly obtained every 0.5 seconds. However, until the time reaches 2 seconds, the video/audio signals of the entire length, which are input up to that point every 0.5 seconds, are input. According to the implementation scheme, a scheme for predicting output while transferring context to the next block on a block basis in a streaming manner may also be applied.

The persona-based back-channel signal information output device receives video/audio signals. Here, text output through a speech recognizer is input together with the audio signals. Next, persona-based back-channel signal information is output using a desired persona model among persona-based back-channel signal information output models that are trained through a fine-tuning process. The model structure of the persona-based back-channel signal information output device is shown in FIG. 4.

The persona-based back-channel signal information output device may be operated to output persona-based back-channel signal information (e.g., video, audio and text labels and the type labels of the back-channel signals) for the corresponding video/audio (text) input, or to output no results when the current input is different from previously learned information and it is predicted that back-channel signal information to be output is not present.

When the back-channel signal information is output, it is transferred to a video/audio (text) signal generator based on the persona-based back-channel signal information and then the process is terminated. Alternatively, the process is terminated when the results are not output. This process is repeated at every preset hop length until the input of video/audio signals is terminated from the start of the video/audio (text) signals.

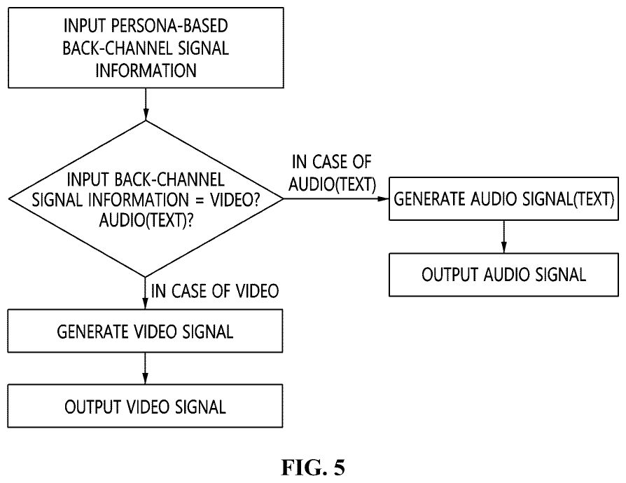

FIG. 5 is a configuration diagram of a video/signal (text) signal generator based on persona-based back-channel signal information.

Referring to FIG. 5, when persona-based back-channel signal information is input, whether the input back-channel signal information is video or audio is identified. In the case where the back-channel signal information is video back-channel signal information, for example, when the type label of the back-channel signal information is ‘emotional-empathy’ and a video output label is ‘nodding (up and down by 30 degrees)’, a digital human, an intelligent robot, or a voice avatar chatbot designed to be capable of outputting the corresponding information may generate and output a resulting signal in a creatable form (e.g., a video signal corresponding to a sympathetic expression nodding up and down at an angle of 30 degrees) based on the back-channel signal information.

In the case where the back-channel signal information is audio back-channel signal information, when the type label of the back-channel signal information is ‘emotional-empathy’, the audio signal information labels are ‘rising intonation’ and ‘duration=0.5 seconds’, and text is ‘right’, a digital human, an intelligent robot, or an audio avatar chatbot designed to be capable of outputting the corresponding information may generate and output a resulting signal in a creatable form (e.g., a signal where speech corresponding to the word “right” is synthesized with a rising intonation over a duration of 0.5 seconds) based on the back-channel signal information. The generation of a video signal and the generation of an audio signal may be independently performed, or simultaneously performed.

According to an embodiment of the present disclosure, the method and apparatus for generating a persona-based multimodal interactive back-channel signal according to the present disclosure are configured to learn back-channel signal information to be output from a database tagged with back-channel signal information, subsequently perform fine-tuning in conformity with a targeted persona, and configure a persona-based multimodal interactive back-channel signal information output device using the fine-tuned results. Next, when actual video/audio (text) signals are input, video/audio (text) signals may be generated by outputting back-channel signal information based on the input video/audio (text) signals.

By means of this process, the present disclosure may engage in not only simple conversation but also interactive conversation by utilizing back-channel signal information. This enhances the naturalness and immersion of a conversation system. In particular, the style of the back-channel signal information that is output during this process may be customized to output results in a desired style according to the persona desired to be reflected by the system, thus obtaining an advantage in that back-channel signals in which various persona styles are reflected may be output.

With these advantages, the present disclosure may enable the configuration of a natural conversation system that generates persona-based multimodal interactive back-channel signals, thus making it possible to feel as though one is conversing with a human with a specific persona.

The advantages of the present disclosure are not limited to the above-described effects, and other advantages that are not described may be clearly understood by those skilled in the art from the description of the specification.

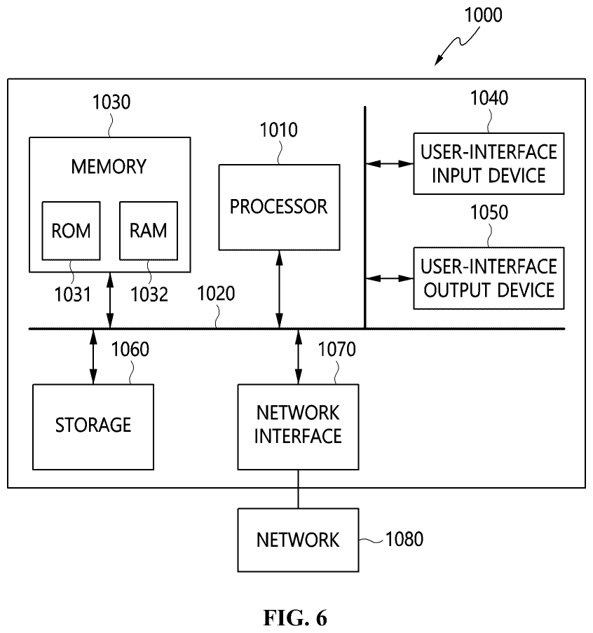

FIG. 6 is a diagram illustrating the configuration of a computer system according to an embodiment.

An apparatus for generating a persona-based multimodal back-channel signal according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

An apparatus for generating a persona-based multimodal back-channel signal according to an embodiment of the present disclosure may include memory configured to store at least one program, and a processor configured to execute the program, wherein the program comprises instructions for performing the step of training an artificial intelligence model that generates back-channel signal information using a multimodal database (DB) with channel signal information labels applied thereto, the step of performing fine-tuning on the artificial intelligence model using a preset speaker database, and the step of generating back-channel signal information for input video or audio based on the artificial intelligence model.

Here, the multimodal database may include data composed of video, audio and text information.

Here, the back-channel signal information label may include video and audio labels of a listener and a speaker, and a back-channel information label of the listener.

Here, the video label may include eye movement, lip shape, gesture, and head movement information, and the audio label may include accent and audio duration information.

Here, the speaker database may be set based on a generation frequency of a back-channel signal of the listener.

Here, the step of training the artificial intelligence model may include the step of determining a length of a multimodal signal that is input to the artificial intelligence model, the step of performing preprocessing on the multimodal signal, and the step of outputting the back-channel signal information based on information in which individual preprocessed signals are concatenated with each other.

Here, the step of generating the back-channel signal information based on the input video or audio may include inputting the input video or audio based on the determined length of the multimodal signal and a preset hop length.

Here, the program may further include an instruction for performing the step of outputting video or audio based on the back-channel signal information.

Here, the back-channel signal information may be video or audio information used by the listener to pay attention to the speaker or to request the speaker to continue talking.

Specific executions described in the present disclosure are embodiments, and the scope of the present disclosure is not limited to specific methods. For simplicity of the specification, descriptions of conventional electronic components, control systems, software, and other functional aspects of the systems may be omitted. As examples of connections of lines or connecting elements between the components illustrated in the drawings, functional connections and/or circuit connections are exemplified, and in actual devices, those connections may be replaced with other connections, or may be represented by additional functional connections, physical connections or circuit connections. Furthermore, unless definitely defined using the term “essential”, “significantly” or the like, the corresponding component may not be an essential component required in order to apply the present disclosure.

According to the present disclosure, customized multimodal interactive back-channel signal information corresponding to a persona may be output.

Further, the present disclosure may provide an interactive conversation service using back-channel signal information.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A method for generating a persona-based multimodal back-channel signal, comprising:
training an artificial intelligence model that generates back-channel signal information using a multimodal database (DB) with channel signal information labels applied thereto;
performing fine-tuning on the artificial intelligence model using a preset speaker database; and
generating back-channel signal information for input video or audio based on the artificial intelligence model.

2. The method of claim 1, wherein the multimodal database comprises data composed of video, audio and text information.

3. The method of claim 1, wherein the back-channel signal information label comprises:
video and audio labels of a listener and a speaker; and
a back-channel information label of the listener.

4. The method of claim 3, wherein:
the video label includes eye movement, lip shape, gesture, and head movement information, and
the audio label includes accent and audio duration information.

5. The method of claim 4, wherein the speaker database is set based on a generation frequency of a back-channel signal of the listener.

6. The method of claim 2, wherein training the artificial intelligence model comprises:
determining a length of a multimodal signal that is input to the artificial intelligence model;
performing preprocessing on the multimodal signal; and
outputting the back-channel signal information based on information in which individual preprocessed signals are concatenated with each other.

7. The method of claim 6, wherein generating the back-channel signal information based on the input video or audio comprises:
inputting the input video or audio based on the determined length of the multimodal signal and a preset hop length.

8. The method of claim 6, further comprising:
outputting video or audio based on the back-channel signal information.

9. The method of claim 1, wherein the back-channel signal information is video or audio information used by the listener to pay attention to the speaker or to request the speaker to continue talking.

10. An apparatus for generating a persona-based multimodal back-channel signal, comprising:
a memory configured to store at least one program; and
a processor configured to execute the program,
wherein the program comprises instructions for performing:
training an artificial intelligence model that generates back-channel signal information using a multimodal database (DB) with channel signal information labels applied thereto;
performing fine-tuning on the artificial intelligence model using a preset speaker database; and
generating back-channel signal information for input video or audio based on the artificial intelligence model.

11. The apparatus of claim 10, wherein the multimodal database comprises data composed of video, audio and text information.

12. The apparatus of claim 10, wherein the back-channel signal information label comprises:
video and audio labels of a listener and a speaker; and
a back-channel information label of the listener.

13. The apparatus of claim 12, wherein:
the video label includes eye movement, lip shape, gesture, and head movement information, and
the audio label includes accent and audio duration information.

14. The apparatus of claim 13, wherein the speaker database is set based on a generation frequency of a back-channel signal of the listener.

15. The apparatus of claim 11, wherein training the artificial intelligence model comprises:
determining a length of a multimodal signal that is input to the artificial intelligence model;
performing preprocessing on the multimodal signal; and
outputting the back-channel signal information based on information in which individual preprocessed signals are concatenated with each other.

16. The apparatus of claim 15, wherein generating the back-channel signal information based on the input video or audio comprises:
inputting the input video or audio based on the determined length of the multimodal signal and a preset hop length.

17. The apparatus of claim 16, wherein the program further comprises an instruction for performing:
outputting video or audio based on the back-channel signal information.

18. The method of claim 10, wherein the back-channel signal information is video or audio information used by the listener to pay attention to the speaker or to request the speaker to continue talking.
